(19) United States
(12) Patent Application Publication
(10) Pub. No.: US 2010/0169952 A1
(43) Pub. Date: Jul. 1, 2010

(54) METHOD, APPARATUS AND COMPUTER PROGRAM PRODUCT FOR PROVIDING AN ADAPTIVE AUTHENTICATION SESSION VALIDITY TIME

(76) Inventors: Jussi Maki, Espoo (FI); Markku Kontio, Tuusula (FI)

Correspondence Address: DITTHAVONG MORI & STEINER, P.C., 918 Prince Street, Alexandria, VA, 22314, US

(21) Appl. No.: 12/345,993

(22) Filed: Dec. 30, 2008

(51) Int. Cl. H04L 9/00; G06F 17/30

(52) U.S. Cl. 726/3

(57) ABSTRACT

An apparatus for providing an adaptive authentication session validity time period may include a processor. The processor may be configured to receive an indication of load parameters indicative of authentication rate information, determine, at the service platform, a value defining a validity period for indicating a period of time during which an authentication session validity object is valid based on the received indication of load parameters, and provide the authentication session validity object to a client device. A corresponding method and computer program product are also provided.

### TECHNOLOGICAL FIELD

Embodiments of the present invention relate generally to network service provision technology and, more particularly, relate to a method, apparatus, and computer program product for providing an adaptive authentication session validity time period.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. However, with the rapid development of communication networks and the corresponding expansion of applications and services accessible via these networks, authentication to each different service or application may be onerous. In this regard, for example, since security is an important consideration to many individuals while utilizing online applications and services, many such applications and services have authentication procedures (e.g., requiring a username and password) that must be followed in order to enable users to have access to the applications and services they desire. This can lead to a relatively large number of passwords and usernames that must be remembered by a user. Alternatively, even if the user can use the same username and password repeatedly, the interruption associated with providing authentication information to many different applications or services within one session with a communication device can be frustrating.

In the context of mobile communication devices, online services are becoming increasingly popular. In this regard, many always on services are becoming popular and services such as instant messaging, voice over Internet Protocol (VoIP), location based services, presence information, social connectivity services, and the like are often employed by users on a nearly continuous basis. Single sign on (SSO) procedures have been developed to provide shared authentication services for multiple services. Thus, using SSO, multiple services may be accessed or utilized with a single authentication sign on. Since different applications and services support different authentication mechanisms, SSO typically involves storage of various different credentials. SSO services can be applied to web based clients and to custom applications (including custom mobile applications) using some form of authentication application programming interface (API).

Authentication APIs may use access tokens that are created with authentication by provision of a username and password. Tokens typically have a fixed validity period after which time they timeout. As such, tokens may need to be refreshed regularly for online services. The fixed validity period of the tokens is used to ensure that users do not remain logged in indefinitely. The tokens may be valid for a group of services, which in the context of Internet service providers may be implemented in different organizations.

An issue that may arise in connection with token usage relates to the impact that session or token validity periods may have on network loading. In this regard, if clients need to refresh authentication tokens every couple hours, the load for token refreshment increases linearly with the increase in the number of clients. For example, ten million clients refreshing tokens every fourth hour may create a nearly constant load of about seven hundred authentications per second. For one hundred million clients, the number of authentications per second would increase ten-fold. Meanwhile, having a longer fixed timeout period for tokens (e.g., two weeks) may be impractical since it may be difficult to revoke tokens over such a long validity period without a specific tracking and revoking mechanism.

Accordingly, it may be desirable to improve SSO procedures relative to session validity mechanisms such as token usage.

### BRIEF SUMMARY

A method, apparatus and computer program product are therefore described herein to provide an adaptive authentication session validity time. In particular, a method, apparatus and computer program product are provided that enable adaptation of authentication session validity time to loading conditions.

In one exemplary embodiment, a method of providing an adaptive authentication session validity time is provided. The method may include receiving an indication of load parameters indicative of authentication rate information, determining a value defining a validity period for indicating a period of time during which an authentication session validity object is valid to enable a client device based on the received indication of load parameters, and providing the authentication session validity object to a client device.

In another exemplary embodiment, a computer program product for providing an adaptive authentication session validity time is provided. The computer program product includes at least one computer-readable storage medium having computer-executable program code instructions stored therein. The computer-executable program code instructions may include program code instructions for receiving an indication of load parameters indicative of authentication rate information, determining a value defining a validity period for indicating a period of time during which an authentication session validity object is valid based on the received indication of load parameters, and providing the authentication session validity object to a client device.

In another exemplary embodiment, an apparatus for providing an adaptive authentication session validity time is provided. The apparatus may include a processor configured to receive an indication of load parameters indicative of authentication rate information, determine a value defining a validity period for indicating a period of time during which an authentication session validity object is valid based on the received indication of load parameters, and provide the authentication session validity object to a client device.

In another exemplary embodiment, an apparatus for providing an adaptive authentication session validity time is provided. The apparatus may include means for receiving an indication of load parameters indicative of authentication rate information, means for determining a value defining a validity period for indicating a period of time during which an authentication session validity object is valid based on the received indication of load parameters, and means for providing the authentication session validity object to a client device.

Embodiments of the invention may provide a method, apparatus and computer program product for SSO authentication performance. As a result, for example, mobile terminal users and users of other communication devices may enjoy improved access to network resources with the potential for less negative impact on network capacity.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a system according to an exemplary embodiment of the present invention;

FIG. 2 is a schematic block diagram of an apparatus for providing an adaptive authentication session validity time according to an exemplary embodiment of the present invention;

FIG. 3 illustrates a signal diagram showing an exemplary embodiment of the present invention; and

FIG. 4 is a block diagram according to an exemplary method for providing an adaptive authentication session validity time according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary” , as used herein, is not provided to convey any qualitative assessment, but instead merely to convey an illustration of an example. Thus, use of any such terms should not be taken to limit the spirit and scope of embodiments of the present invention.

In certain environments, such as when multiple services and/or applications are desired to be made accessible for client usage from a server or other service platform, the SSO procedures described above may generally be employed. However, according to embodiments of the present invention, rather than employing fixed validity periods for defining the validity of an authentication session validity object (e.g., a token) to be a fixed value that may prove to be too long, have too great an impact on resource consumption, or otherwise negatively impact network resources, an adaptive authentication session validity time may be provided.

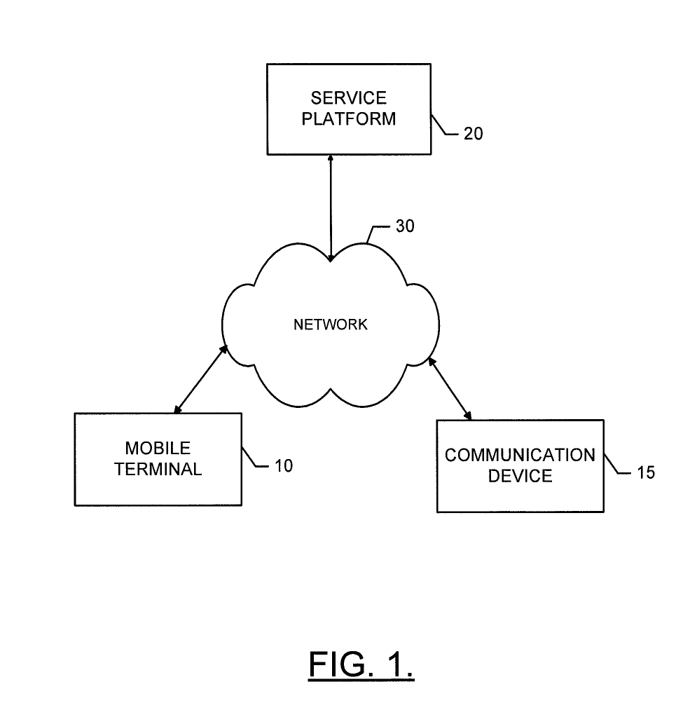

FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention. As shown in FIG. 1, an embodiment of a system in accordance with an example embodiment of the present invention may include a user terminal 10, such as a mobile terminal, capable of communication with numerous other devices including, for example, a service platform 20 via a network 30. In some embodiments of the present invention, the system may further include one or more additional communication devices (e.g., communication device 15) such as other mobile terminals, personal computers (PCs), servers, network hard disks, file storage servers, and/or the like, that are capable of communication with the mobile terminal 10 and accessible by the service platform 20. However, not all systems that employ embodiments of the present invention may comprise all the devices illustrated and/or described herein. Moreover, in some cases, embodiments may be practiced on a standalone device independent of any system.

The user terminal 10 may be any of multiple types of mobile communication and/or computing devices such as, for example, portable digital assistants (PDAs), pagers, mobile televisions, mobile telephones, gaming devices, laptop computers, cameras, camera phones, video recorders, audio/video players, radios, global positioning system (GPS) devices, or any combination of the aforementioned, and other types of voice and text communications systems. While the user terminal 10 may be mobile as indicated by a number of the foregoing examples, the user terminal may be a fixed communication device in other embodiments. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30.

Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the user terminal 10 and the other devices (e.g., service platform 20, or other mobile terminals or devices such as the communication device 15) to the network 30, the user terminal 10 and/or the other devices may be enabled to communicate with each other, for example, according to numerous communication protocols, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi (Wireless Fidelity), ultra-wide band (UWB), Wibree techniques and/or the like and fixed access mechanisms such as digital subscriber line (DSL), cable modems, Ethernet and/or the like.

In an example embodiment, the service platform 20 may be a device or node such as a server or other processing element. The service platform 20 may have any number of functions or associations with various services and/or applications. As such, for example, the service platform 20 may be a platform such as a dedicated server (or server bank) associated with a particular information source or service (e.g., a service associated with sharing music or other media content, a social network, a gaming service, and/or the like), or the service platform 20 may be a backend server associated with one or more other functions or services. As such, the service platform 20 represents a potential host for a plurality of different services or information sources. Moreover, the service platform 20 may, in some cases, be a source for accessing a plurality of different applications and services via a single platform (e.g., Nokia's Ovi service). Access to all of the applications and/or services available via the service platform 20 may be provided after a single sign on (SSO) authentication. In some embodiments, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with embodiments of the present invention.

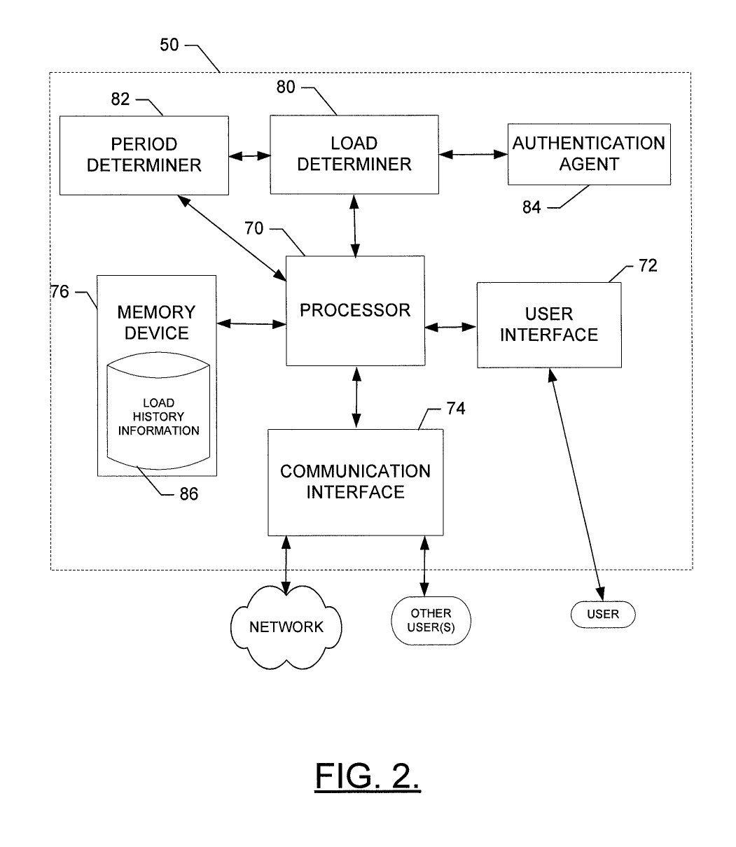

In an exemplary embodiment, the service platform 20 may employ an apparatus (e.g., the apparatus of FIG. 2) capable of employing embodiments of the present invention. As such, FIG. 2 illustrates a block diagram of an apparatus that may benefit from embodiments of the present invention. It should be understood, however, that the apparatus as illustrated and hereinafter described is merely illustrative of one apparatus that may benefit from embodiments of the present invention and, therefore, should not be taken to limit the scope of embodiments of the present invention. In one exemplary embodiment, the apparatus of FIG. 2 may be employed on a server or other network device (e.g., service platform 20) capable of communication with other devices via a network, and further capable of providing authentication services to clients accessing resources associated with the service platform 20. However, in some cases, the apparatus on which embodiments of the present invention are practiced may be located in other devices. As such, not all systems that may employ embodiments of the present invention are described herein. Moreover, other structures for apparatuses employing embodiments of the present invention may also be provided and such structures may include more or less components than those shown in FIG. 2. Thus, some embodiments may comprise more or less than all the devices illustrated and/or described herein. Furthermore, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 2, an apparatus 50 for employing an adaptive authentication session validity time is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may otherwise be a general purpose processing element if not for the specific configuration provided by the instructions, to perform the algorithms and operations described herein. However, in some cases, the processor 70 may be a processor of a specific device (e.g., a mobile terminal) adapted for employing embodiments of the present invention by further configuration of the processor 70 by instructions for performing the algorithms and operations described herein.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated.

In an exemplary embodiment, the processor 70 may be embodied as, include or otherwise control a load determiner 80, an adaptive session validity period determiner (or period determiner 82) and an authentication agent 84. The load determiner 80, the period determiner 82 and the authentication agent 84 may each be any means such as a device or circuitry embodied in hardware, software or a combination of hardware and software that is configured to perform corresponding functions of the load determiner 80, the period determiner 82 and the authentication agent 84, respectively.

In an exemplary embodiment, the load determiner 80 may be configured to measure load parameters at the service platform 20 (or in some cases more specifically at the authentication agent 84). The load parameters measured may be communicated to the period determiner 82 for further processing and, in some cases, may also be stored at a location (e.g., the memory device 76 as load history information 86). The load parameters measured by the load determiner 80 may include any of a number of parameters such as bandwidth parameters, requests associated with particular clients and/or services, and the like. However, in an exemplary embodiment, the load determiner 80 may be configured to at least monitor authentication rate information. In particular, in an exemplary embodiment, the load determiner 80 is an agent used to determine the rate (e.g., measured in authentications per second) at which re-authentications are processed by the authentication agent 84.

The authentication agent 84 may be configured to receive authentication and re-authentication requests from client devices (e.g., the user terminal 10) in relation to accessing services including resources and applications associated with or otherwise provided by the service platform 20. In response to proper authentication of a client device, the client device may be issued an authentication session validity object (e.g., a token) with a given validity period defining the time for which the token is valid. After expiration of the validity period, the client device may request re-authentication, which may also be handled by the authentication agent 84. The authentication agent 84 may be configured to issue a new token with a validity period that may or may not be the same as the initial validity period defined for the client device. In an exemplary embodiment, the validity period defined for the token may be determined by the period determiner 82.

In an exemplary embodiment, the period determiner 82 may be configured to receive load parameter information from the load determiner 80 and determine a suitable validity period based on the load parameters. In this regard, in some cases, the period determiner 82 may compare rates of re-authentications to particular thresholds to determine whether to decrease the validity period (e.g., make the time period of validity shorter) or whether to increase the validity period (e.g., make the time period of validity longer) based on the re-authentication rate. For example, if the re-authentication rate reaches a high watermark (e.g., a high threshold), the period determiner 82 may be configured to increase the validity period to attempt to reduce the re-authentication rate and correspondingly reduce the consumption of bandwidth and processing resources otherwise expended for re-authentication purpose. Meanwhile, if the re-authentication rate reaches a low watermark (e.g., a low threshold), the period determiner 82 may be configured to decrease the validity period to attempt to increase the re-authentication rate to provide increase authentication control in instances in which the bandwidth and processing resources are available for such re-authentication purposes. In some embodiments, the period determiner 82 may be configured with predefined maximum and/or minimum validity periods that may be provided for token issuance.

In some instances, reductions in validity period may be maintained in place until a high threshold of authentication rate is met, at which time an increase in validity period may be instituted. Similarly, increases in validity period may be maintained in place until a low threshold of authentication rate is met, at which time decrease in validity period may be instituted. The period determiner 82 may also be configured to modify validity periods for tokens to be issued in response to other stimuli as well. For example, instead of basing validity period modifications solely on the rates of authentication or re-authentication, the period determiner 82 could base modification determinations on percentages of change or the rate of change of the authentication or re-authentication rates. Furthermore, a magnitude of the change in validity period may be either a predetermined increment or may be varied based on the rate of change of the authentication rates measured, or other historical or real-time factors.

In an exemplary embodiment, the period determiner 82 may be further configured to set validity period values in consideration of predictive factors. For example, the load history information 86 may be accessed by the period determiner 82 in order to predict a validity period for expected conditions over a given future period of time. As such, for example, the period determiner 82 may be configured to determine patterns in re-authentication rates at various different times of the day, on various calendar days, on various days of the week, etc. The patterns may be indicative of periods that can be expected to have relatively high or low re-authentication rates associated therewith. During expected periods of high re-authentication rates based on historical statistics (e.g., from the load history information 86), the period determiner 82 may preemptively increase the validity period to reduce re-authentication rates. Meanwhile, during expected periods of low re-authentication rates based on historical statistics (e.g., from the load history information 86), the period determiner 82 may preemptively decrease the validity period to increase re-authentication rates. In some embodiments, the period determiner 82 may be configured to employ both predictive techniques and reactive techniques to balance re-authentication rates based on predictive and actual data. Thus, unpredictable peaks may also be handled in embodiments that employ predictive techniques.

Embodiments of the present invention may apply token session validity periods on a global or per service basis. Accordingly, in at least some embodiments, authentication services provided by the authentication agent 84 may be guided by a determination from the period determiner 82 as to a validity period to be applied to issued tokens in order to mitigate peaks and valleys in authentication rates. Some embodiments therefore provide overload protection based on historical and/or current load conditions.

Although embodiments of the present invention have been described in which the validity period is increased when the re-authentication rate reaches a high watermark and decreased when the re-authentication rate reaches a low watermark, the period determiner 82 of other embodiments may be configured to similarly adjust the validity period at re-authentication rates between the high and low watermarks. In this regard, a neutral level or region may be defined between the high and low watermarks representing a re-authentication rate or range of re-authentication rates that is desired. As the load determiner 80 determines that the re-authentication rate exceeds the neutral level or region, the period determiner 82 of one embodiment may be configured to begin increasing the validity period even though the re-authentication rate has not yet reached the high watermark in an effort to reduce the re-authentication rate before it reaches the high watermark. In this regard, the period determiner 82 need not always increase the validity period by equal amounts. Instead, in this embodiment, the period determiner 82 may increase the validity period by greater amounts as the re-authentication rate continues to climb toward the high watermark with the greatest increase in the validity period occurring when the re-authentication rate reaches the high watermark. Conversely, as the load determiner 80 determines that the re-authentication rate falls below the neutral level or region, the period determiner 82 of one embodiment may be configured to begin decreasing the validity period even though the re-authentication rate has not yet reached the low watermark in an effort to increase the re-authentication rate before it reaches the low watermark. As before, the period determiner 82 need not always decrease the validity period by equal amounts. Instead, in this embodiment, the period determiner 82 may decrease the validity period by greater amounts as the re-authentication rate continues to fall toward the low watermark with the greatest increase in the validity period occurring when the re-authentication rate reaches the low watermark.

Additionally, although embodiments of the present invention have been described in which the validity period of all tokens issued at one period of time are the same, other embodiments of the present invention may be configured to control the re-authentication rate by altering the percentage of tokens that are issued with longer or shorter validity periods. In this regard, instead of uniformly increasing the validity period for all tokens upon reaching the high watermark, other embodiments of the present invention may increase the percentage of tokens having a longer validity period upon reaching the high watermark, even though all tokens that are issued do not have the longer validity period. Conversely, instead of uniformly decreasing the validity period for all tokens upon reaching the low watermark, other embodiments of the present invention may increase the percentage of tokens having a shorter validity period upon reaching the low watermark, even though all tokens that are issued do not have the shorter validity period. Similarly, at re-authentication rates between the high and low watermarks, the percentage of tokens that are issued with a longer validity period may be increased as the re-authentication rate climbs toward the high watermark and may be decreased as the re-authentication rate falls toward the low watermark. By controlling the percentages of the tokens for which the validity period is adjusted as well as the size of the adjustment, embodiments of the present invention may provide even more granular control over the re-authentication rate.

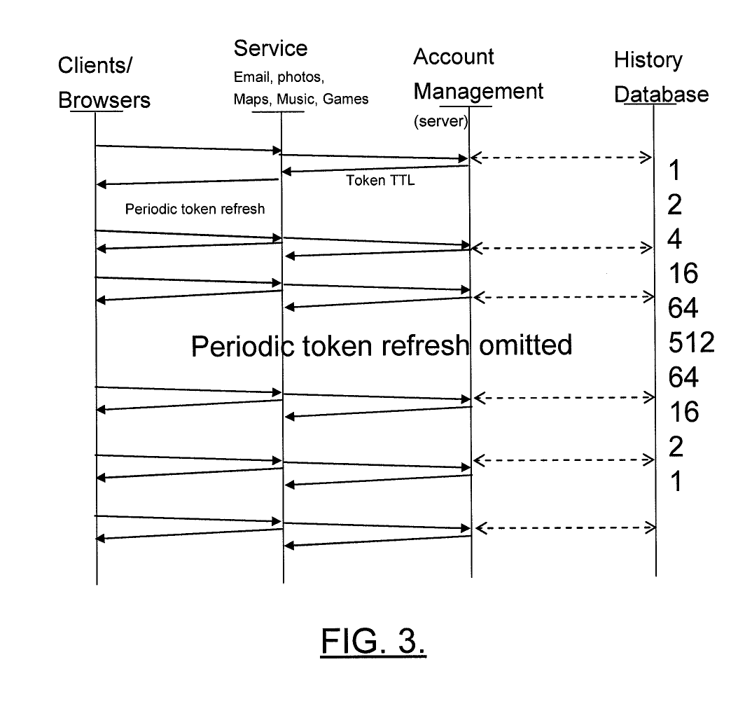

FIG. 3 illustrates a signal diagram showing an exemplary embodiment of the present invention. In this regard, a client or browser (e.g., associated with the mobile terminal 10) may have a token associated with a service refreshed as shown in FIG. 3 via an account manager (e.g., apparatus 50) performing account management operations. As shown in FIG. 3, different service categories may have different TTL (time to live) parameters. For example, email accounts may have shorter intervals for refreshing tokens than photos services. An identity of the service may be received and handled in the account manager. In one embodiment this service identity may influence the periodic refresh of token TTL in addition to the load parameter.

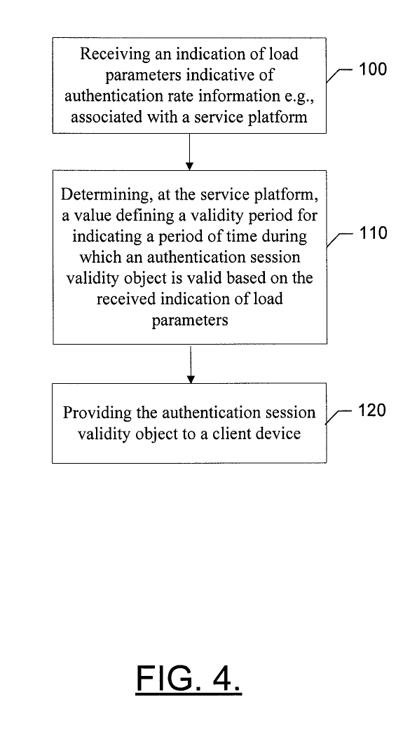

FIG. 4 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., the processor 70). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). In some embodiments, the computer program instructions are stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing adaptive authentication session validity times as provided in FIG. 4 may include receiving an indication of load parameters indicative of authentication rate information associated with a service platform at operation 100, determining, at the service platform, a value defining a validity period (e.g., variable) for indicating a period of time during which an authentication session validity object is valid based on the received indication of load parameters at operation 110, and providing the authentication session validity object to the client device at operation 120. The value determined may enable a client device to access a plurality of services associated with the service platform.

In some embodiments, the operations described above may be modified. Such modifications may be performed in any order and/or in combination with each other in various alternative embodiments. As such, for example, receiving the indication of load parameters may include receiving re-authentication rate information associated with devices requesting issuance of a subsequent authentication session validity object. In some cases, receiving the indication of load parameters may include receiving an indication that an authentication rate has reached a threshold value. In an exemplary embodiment, determining the value may include selecting a modified validity period that increases the value in response to an upper limit threshold value being reached and decreases the value in response to a lower limit threshold value being reached. In some situations, receiving the indication of load parameters may include receiving historical data on past authentication rate information. In an exemplary embodiment, determining the value may include selecting the value to mitigate predicted peaks and valleys in authentication rates based on the historical data.

In an exemplary embodiment, an apparatus for performing the method of FIG. 4 above may comprise a processor (e.g., the processor 70) configured to perform some or each of the operations (100-120) described above. The processor may, for example, be configured to perform the operations (100-120) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-120 may comprise, for example, the processor 70 (e.g., as means for performing any of the operations described above), the period determiner 82 alone or in combination with the authentication agent 84, and/or an algorithm executed by the processor 70 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of load parameters indicative of authentication rate information;
determining a value defining a validity period for indicating a period of time during which an authentication session validity object is valid based on the received indication of load parameters; and
providing the authentication session validity object to a client device.

2. The method of claim 1, wherein receiving the indication of load parameters comprises receiving re-authentication rate information associated with devices requesting issuance of a subsequent authentication session validity object.

3. The method of claim 1, wherein receiving the indication of load parameters comprises receiving an indication that an authentication rate has reached a threshold value.

4. The method of claim 3, wherein determining the value comprises selecting a modified validity period that increases the value in response to a upper limit threshold value being reached and decreases the value in response to a lower limit threshold value being reached.

5. The method of claim 1, wherein receiving the indication of load parameters comprises receiving historical data on past authentication rate information.

6. The method of claim 5, wherein determining the value comprises selecting the value to mitigate predicted peaks and valleys in authentication rates based on the historical data.

7. A computer program product comprising at least one computer-readable storage medium having computer-executable program code instructions stored therein, the computer-executable program code instructions comprising:
program code instructions for receiving an indication of load parameters indicative of authentication rate information;
program code instructions for determining a value defining a validity period for indicating a period of time during which an authentication session validity object is valid based on the received indication of load parameters; and
program code instructions for providing the authentication session validity object to a client device.

8. The computer program product of claim 7, wherein program code instructions for receiving the indication of load parameters include instructions for receiving re-authentication rate information associated with devices requesting issuance of a subsequent authentication session validity object.

9. The computer program product of claim 7, wherein program code instructions for receiving the indication of load parameters include instructions for receiving an indication that an authentication rate has reached a threshold value.

10. The computer program product of claim 9, wherein program code instructions for determining the value include instructions for selecting a modified validity period that increases the value in response to a upper limit threshold value being reached and decreases the value in response to a lower limit threshold value being reached.

11. The computer program product of claim 7, wherein program code instructions for receiving the indication of load parameters include instructions for receiving historical data on past authentication rate information.

12. The computer program product of claim 11, wherein program code instructions for determining the value include instructions for selecting the value to mitigate predicted peaks and valleys in authentication rates based on the historical data.

13. An apparatus comprising a processor configured to:
receive an indication of load parameters indicative of authentication rate information;
determine a value defining a validity period for indicating a period of time during which an authentication session validity object is valid based on the received indication of load parameters; and
provide the authentication session validity object to a client device.

14. The apparatus of claim 13, wherein the processor is configured to receive the indication of load parameters by receiving re-authentication rate information associated with devices requesting issuance of a subsequent authentication session validity object.

15. The apparatus of claim 13, wherein the processor is configured to receive the indication of load parameters by receiving an indication that an authentication rate has reached a threshold value.

16. The apparatus of claim 15, wherein the processor is configured to determine the value by selecting a modified validity period that increases the value in response to a upper limit threshold value being reached and decreases the value in response to a lower limit threshold value being reached.

17. The apparatus of claim 13, wherein the processor is configured to receive the indication of load parameters by receiving historical data on past authentication rate information.

18. The apparatus of claim 17, wherein the processor is configured to determine the value by selecting the value to mitigate predicted peaks and valleys in authentication rates based on the historical data.

19. An apparatus comprising:
means for receiving an indication of load parameters indicative of authentication rate information;
means for determining a value defining a validity period for indicating a period of time during which an authentication session validity object is valid based on the received indication of load parameters; and
means for providing the authentication session validity object to a client device.

20. The apparatus of claim 19, wherein means for receiving the indication of load parameters comprises means for receiving re-authentication rate information associated with devices requesting issuance of a subsequent authentication session validity object.
